(19) United States
(12) Patent Application Publication
(10) Pub. No.: US 2005/0031181 A1
(43) Pub. Date: Feb. 10, 2005

(54) Method and system for analyzing bone conditions using DICOM compliant bone radiographic image

(76) Inventors: Xiaoli Bi, Cerritos, CA (US); Jerry McLaughlin, Palos Verdes, CA (US); Johnny R. Weikel, Del Aire, CA (US); Louai Al-Dayeh, Torrance, CA (US)

Correspondence Address: PERKINS COIE LLP, POST OFFICE BOX 1208, SEATTLE, WA, 98111-1208, US

(21) Appl. No.: 10/873,748

(22) Filed: Jun. 21, 2004

Related U.S. Application Data
(60) Provisional application No. 60/480,306, filed on Jun. 19, 2003.
(60) Provisional application No. 60/551,623, filed on Mar. 8, 2004.

(51) Int. Cl. G06K 9/00

(52) U.S. Cl. 382/132

(57) ABSTRACT

A method and system for in use in diagnosing or monitoring a bone or joint condition in a patient are disclosed. In practicing the method, there is obtained at one site, a digitized, radiographic image of a bone. This image is entered in the image section of a DICOM compliant file also containing a patient-data section. At the same or a different site, bone-analysis software is applied to the digitized radiographic image, to obtain data relating to such bone condition, and this data is entered into the patient-data section of the DICOM file. One or both of the DICOM sections can be accessed at the same site or a site that is remote from one or both of above sites. In addition, a bone-analysis software may be installed in a server and applied to analyze the digitized radiographic image to obtain resulting data. The data may be sent out as a link or a report file.

### CROSS-REFERENCE TO RELATED APPLICATIONS

This application claims the benefit of U.S. Provisional Application No. 60/480,306, filed Jun. 19, 2003, and U.S. Provisional Application No. 60/551,623, filed Mar. 8, 2004, both of which are hereby incorporated by reference in their entirety including drawings.

### FIELD OF THE INVENTION

The present invention relates to a method and system for analyzing bone conditions, such as osteoporosis or arthritis, using a bone analysis software with DICOM compliant image data.

### BACKGROUND OF THE INVENTION

In diagnosing and treating a variety of bone and joint diseases, such as osteoporosis or rheumatoid arthritis, it is common to take radiographic images of the patient, e.g., skeletal features of the patient, then either “read” the images directly or perform software analysis on the images to extract information of interest. For example, in diagnosing or monitoring the treatment of osteoporosis, one might take x-ray images of selected skeletal bones, then perform computer analysis on certain image features to determine bone volume, bone length, bone geometric changes, bone strength conditions, bone age, bone cortical thickness, and bone mineral mass. Co-owned U.S. Pat. No. 6,246,745 (the '745 patent) describes a software system for determining bone mineral density from radiographic images of a patient hand, using bone segmentation and contour analysis algorithms. As another example, a software system capable of measuring the extent of rheumatoid arthritis, by segmentation and contour analysis of patient digit joints, is described in co-owned U.S. patent application Ser. No. 10/625,444 (the '444 application), titled “Method, Code, and System for assaying Joint Deformity,” filed Jul. 22, 2003, which claims the benefit of U.S. Provisional Application Ser. No. 60/397,943, filed Jul. 22, 2002 (the '943 application). Co-owned U.S. Pat. No. 6,711,282, titled “Method for Automatically Segmenting a Target Bone,” (the '282 patent) discloses a method for segmenting digits as part of the bone analyses procedures. All three co-owned patent and applications are incorporated herein.

Typically, for reading and interpreting radiographic images directly, the treating physician will refer the patient to a radiologist, who will then supervise both taking the radiographic image and interpreting the image to extract desired bone information, such as bone mass and bone contour irregularities. Alternatively, if the bone or joint analysis is done, at least partially, by a computer analysis system, the x-ray images prepared by the radiologist may be sent back to the treating physician's computer site or to another computer site for computer analysis.

With each transfer of patient images and information, e.g., between the treating physician and radiologist, or between radiologist and computer analysis site, there may be considerable file material to be transferred, and the transfer may be between remote sites, requiring that the file material be mailed. Such file transfer involves increased time and reduced efficiency, in addition to the risk of losing or having to duplicate critical steps in making and analyzing radiographic images.

Currently, medical images, e.g., X-ray, CT, MRI, PET, or ultrasound images, may be communicated from a physician through the Digital Image Communication in Medicine (DICOM) system. The DICOM system provides a protocol to formatting and sending medical images, allowing users, e.g., physicians at a number of different sites to view and print medical images, and to add additional patient information, including diagnostic information, to the file. However, there is currently no system for performing computer analyses of DICOM-compliant radiographic absorptiometry images, for purposes detecting or diagnosing bone and/or joint conditions, and for embedding various type of bone information derived from the analysis, such as bone mineral mass, bone volume, bone length, cortical thickness, cortical bone mass, contour irregularities, joint space dimensions, and fracture risk prediction, in a DICOM patient-data file.

It would therefore be desirable to provide a method and system for integrating bone radiographic procedures so that the various imaging, analysis and reporting procedures can be carried out efficiently and without risk of losing important image or data information.

### SUMMARY OF THE INVENTION

The invention includes, in one aspect, a method for in use in diagnosing or monitoring a bone or joint condition in a patient using radiographic absorptiometry technology combined with DICOM compliant systems. The method includes (a) obtaining, at one site, a digitized, radiographic image of (i) a skeletal region (e.g., a bone or a cluster of bones) of the patient and (ii) a reference wedge by which anatomical features of the skeletal region can be calibrated; (b) embedding the obtained radiographic image in the image section of a DICOM file also containing a patient-data section; (c) applying bone-analysis software to the digitized radiographic image, at the one or a different site, to obtain data relating to such bone or joint condition, and (d) entering data from step (c) in the patient-data section of the DICOM file. One or both DICOM sections may be accessed at a site where the DICOM file is generated or that is remote from at least one of the one or different sites.

In one general embodiment, a DICOM file is established at one site, e.g., at the site where the digitized radiographic image is obtained and sent to a second site, such as the treating physician site. Typically, patient information is entered and image data is obtained input at the originating site. In this embodiment, the steps identified as (a)-(d) may be carried out at the original site, e.g., a radiology department or clinic. In another embodiment, the steps identified as (a) and (b) are carried out at one site (the originating site), e.g., the radiology department, and steps (c) and (d) are carried out at a second site, e.g., the treating physician who received the DICOM file by network or internet, whereas the digitized radiographic image in DICOM format is transferred from the originating site to the second site or obtained from the originating site.

In another embodiment, the steps identified as (a) and (b) are carried out at an originating site, e.g., the radiology department; steps (c) and (d) in the method are carried out at an analysis site; and the resulting data are obtained in the originating site, the analysis site, or a third site (e.g., doctor's office).

In another embodiment, each step from (a) through (d) can be carried out at separate sites, as far as data or images can be transferred from one site to another or can be stored in a centralized server and accessed from various sites.

The software used for image analysis is operable to open a DICOM formatted file, to obtain patient demographics as well as image information from the DICOM header, to extract region of interest section from the DICOM radiographic images, after applying the software to obtain data relating to such bone or joint condition, to embed such data to the DICOM patient-data group. The DICOM file may be stored and/or accessed on a Picture Archiving and Communications System (PACS).

For use in assaying or monitoring changes in bone mineral density in a patient, step (a) may be carried out to obtain a digitized, radiographic image of (i) one or more fingers of one of the patient's hand, and step (c) may include segmenting the middle phalange of at least one finger in the radiographic images, and determining a bone mineral density value based on the contours of each segment in the phalange of the finger.

For use in assaying or monitoring the progression of a joint degenerative disease such as rheumatoid arthritis in changes in bone mineral density in a patient, step (a) may be carried out to obtain a digitized, radiographic image of (i) one or more fingers of one of the patient's hand, and step (c) may include:
(i) determining right and left bone contours of at least a middle region of the middle phalange of the finger,
(ii) matching the right and left bone contours in a middle region of the middle phalange of the patient finger with those of a normal-finger template from a normal database, to select a template that matches the patient finger,
(iii) superimposing the selected middle phalange template on the image of the patient-finger middle phalange,
(iv) using the contours of the template finger to identify a scanning box at the middle phalange/proximal phalange (MP/PP) joint,
(v) scanning the MP/PP joint within the scanning box, in scanning directions parallel to the axis of the finger, to generate contours of the confronting ends of the middle and proximal phalanges in the MP/PP joint,
(vi) generating a profile of the distances between the MP/PP bone-end contours within the scan box, and
(vii) analyzing the profile from (vi) to determine the extent of bone loss at the MP/PP joint, as an indicator of extent or progression of joint-degenerative disease in the patient.

The patient-data section of the DICOM file may include tags to identify various types of patient information. Here the method may further include adding to the patient-data section, additional tags for entering data relating to the patient's osteoporosis status, including one or more of bone mineral mass, bone volume, bone length, bone geometric changes, both strength, bone age, cortical thickness, cortical bone mass, trabecular bone mass, T-score, Z-score, fracture prediction probability, and diagnostic statement.

In another aspect, the invention includes a system for use in diagnosing or monitoring a bone or joint condition in a patient. The system includes a template for use obtaining a radiographic image of a skeletal region of one of the patient's hands, the template indicating the placement of the hand on the template and an x-ray wedge by which anatomical features of the skeletal region can be calibrated. Further included in the system is software designed to be executed on a site computer. The software is operable to: (a) set up a new DICOM-compliant file with image and patient-data information, (b) transfer a radiographic image, in digitized form, to the image section of a DICOM file, (c) apply bone-analysis software to the digitized radiographic image, to obtain data relating to such bone or joint condition, and (d) permit entry data from step (c) in the patient-data section of the DICOM file. The file at any stage may be sent to another computer site and/or to an archival site where the file may be stored and accessed by other users.

The software may be operable to open a DICOM file, transfer digitized radiographic images from the DICOM file to the site computer and, after applying the software to obtain data relating to such bone or joint condition, to transfer such data from the site computer to the DICOM patient-data in the header. The system may operate to store and/or access the DICOM file as a component object module (COM) on a Picture Archiving and Communications System (PACS).

In another aspect, the invention includes a computer system for analyzing a bone condition comprising a server, wherein the server contains a bone analysis software and is used by a user to receive a file containing a bone image; analyze the bone image using the software on the server; and deliver an analysis result to the user.

In another aspect, the invention is directed to a method of method of analyzing a bone condition using a bone analysis software installed in a server comprising the steps of: sending a file containing a bone image to a server wherein the server contains bone analysis software; analyzing the bone image using the software in the server; and receiving an analysis result from the server

These and other objects and features of the invention will become more fully apparent when the following detailed description of the invention is read in conjunction with the accompanying drawings.

### BRIEF DESCRIPTION OF THE FIGURES

FIG. 1 shows different components and sites involved in an exemplary DICOM-compliant system in accordance with the invention;

FIG. 2 shows an osteogram template used in the invention for making a radiographic image of a patient hand, representative skeletal regions of which are shown;

FIG. 3 shows key components and operations in a system for determining bone mineral density, in accordance with one embodiment of the invention;

FIG. 4 shows key components and operations in a system for determining the progression of joint pathology associated with arthritis, in accordance with another embodiment of the invention;

FIG. 5 shows typical data fields in a final, archived DICOM patient record;

FIG. 6 shows key components and operations for establishing and adding patient data and image(s) to a DICOM-compliant file in accordance with the invention;

FIGS. 7A and 7B are flow diagrams of operations carried out by input and output convert modules, respectively, in the system software of the invention; and

FIG. 8 shows components of the system software of the invention.

FIG. 9 shows different components and sites involved in another exemplary DICOM-compliant system in accordance with the invention.

FIG. 10 shows exemplary components and sites involved in using bone analysis software in a server in accordance with the invention.

### DETAILED DESCRIPTION OF THE INVENTION

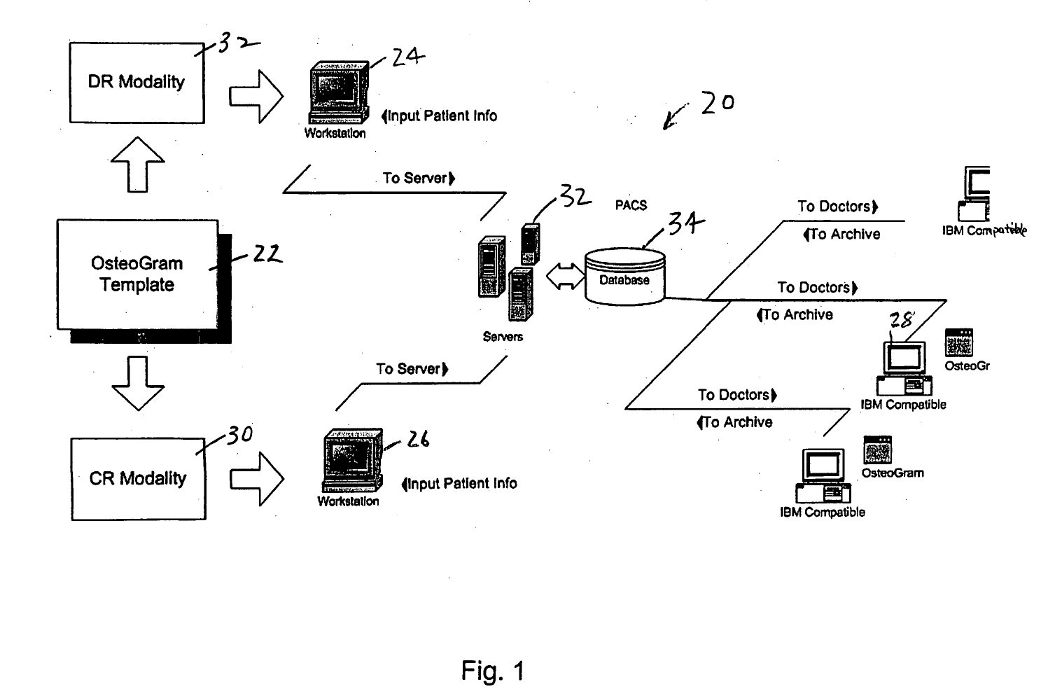

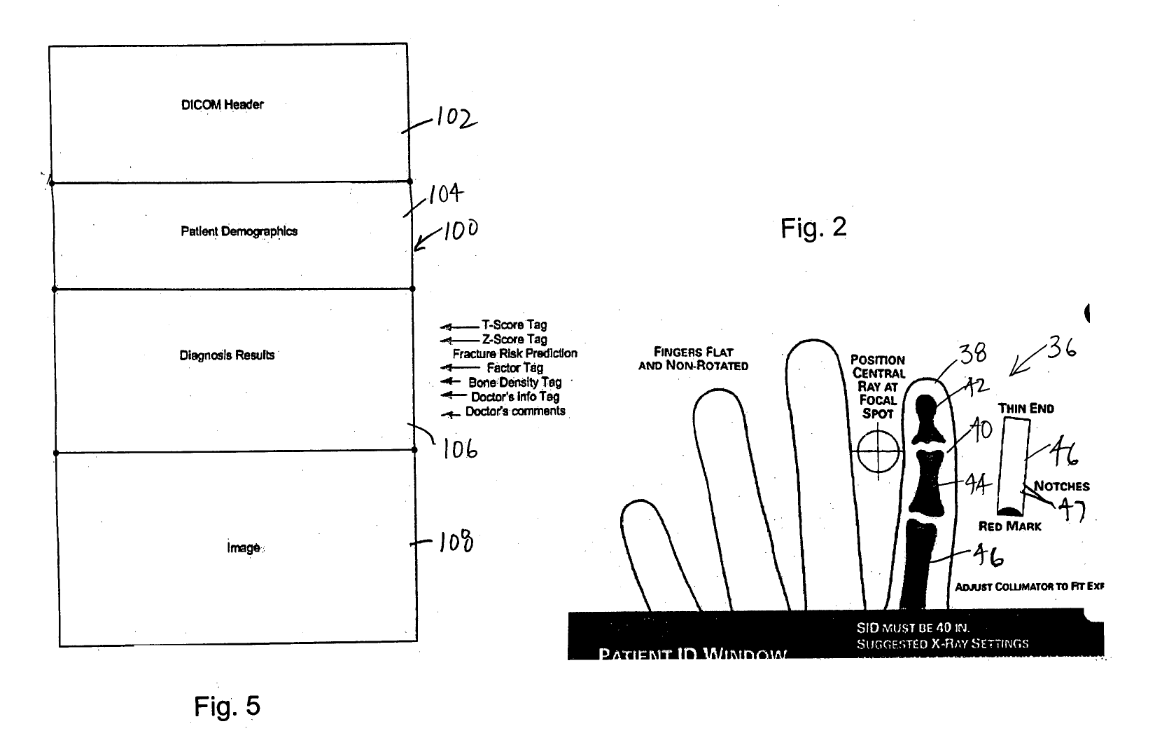

FIG. 1 shows components of a system 20, constructed according to the present invention, for multi-site diagnosing or monitoring of patient bone or joint conditions. The system includes an x-ray template 22, described below with respect to FIG. 2, and software operating on a site computer, such as computers 24, 26, 28 for carrying out various image retrieval and analysis operation to be described below.

The x-ray template is used in taking radiographic images of a patient site, typically a hand region, and in particular, three digits of one or both hands. As discussed below, the template includes an x-ray calibration wedge by which anatomical features of the patient skeletal region of interest can be calibrated. The template may be used with different modalities such as a computed radiograph (CR) plate or a direct radiograph (DR) detector 32 to obtain suitable digital images.

The software in site computers 24, 26 is designed, in accordance with the invention and as described below, for formatting the patient radiographic image in a DICOM format. More specifically, each site computer is designed to retrieve and view the content of, and optionally, to analyze image in, a DICOM-compliant file that has both an image data section for a patient radiographic image in DICOM-compliant form and a patient-data section into which is entered patient information and analytical information generated by image analysis.

FIG. 1 illustrates site computers 24, 26 for receiving image data, either in CR or DR format, and patient information. Together, the image and patient information form a DICOM patient file that can then be transmitted to other sites for analysis and/or retrieval and inspection. The site-computer software may additionally include analytical modules for carrying out one of a variety of image-analyses on the stored image, including, in the case of a patient hand image, phalange segmentation, bone mineral density determination, and/or analysis of joint degeneration. Alternatively, the system may include one or more site computers, such as site computers 24, 26, whose software is designed for establishing patient DICOM files, and other site computers, such as computer 28, that contain analytical software for communicating with DICOM-compliant files, for determining bone and/or joint information from the file image(s), and for modifying the accessed file to include additional bone-analysis information, such as bone mineral mass, bone volume, bone mineral density, bone length, cortical thickness, cortical bone mass, trabecular bone mass, T-score, Z-score, fracture risk prediction, and a diagnostic statement.

Thus, the patient DICOM file generated at site computers such as 24, 26 may or may not contain analytical information generating from the file images. In any case, the images may be stored in a local server, indicated at 32 for storage and distribution to other site computers. In the system shown, the files are sent from the local server for archiving in a widely accessible archiving system, such as the Picture Archiving and Communications System (PACS), as shown at 34 in the figure. This archiving, as indicated, allows all PACS users to access the file, thus providing general distribution of the file to physicians at many different sites. This feature is illustrated at the right in the figure, which shows medical personnel at several different sites accessing the file independently at their site computers, such as computer 28. As noted above, the file image may be used for analytical purposes at one or more of these sites, or if image-analysis has been done at another site, for interpretation and/or patient consultation. After use, the files can be returned to the source archive (PACS or original-site server) for storage.

FIG. 2 shows an osteogram template 36 used in the invention for producing radiographic images of a patient hand region. The template provides guides, such as guide 38, to indicate the placement of a patient's index and adjacent three fingers, such as patient finger 40, when the radiographic image is taken. This ensures approximated desired placement of critical hand skeletal structures. In the figure, the three phalanges for each finger, such as distal, middle and proximal phalanges 42, 44, 46, of finger 40, respectively, are shown, indicating the relationship between the template guide and phalange structures of interest. In particular, the phalange structures of interest include the middle phalange, such as phalange 42 and proximal phalange, such as phalange 44, of one or more of the three fingers. Also included in the template is a radio-opaque calibration wedge 46 for calibrating. Wedge 46 includes a thin upper end 47, and a plurality of notches 49 along one side thereof.

The calibration wedge in the template is used to adjust for differences among x-ray equipment, exposures, type of film, the development process, and information of pre-processing used in digital x-ray modalities. In particular, the size and image density of the wedge in the radiographic image can be used to calibrate size and image density of the skeletal features in the image. Further details on the use of the calibration wedge in bone and/or joint analysis are given in the above-cited '745 patent and '282 patent. As noted above, the radiographic patient image taken on the osteogram template may be in DR or CR format, yielding a digitized image suitable for formatting for a DICOM-compliant file.

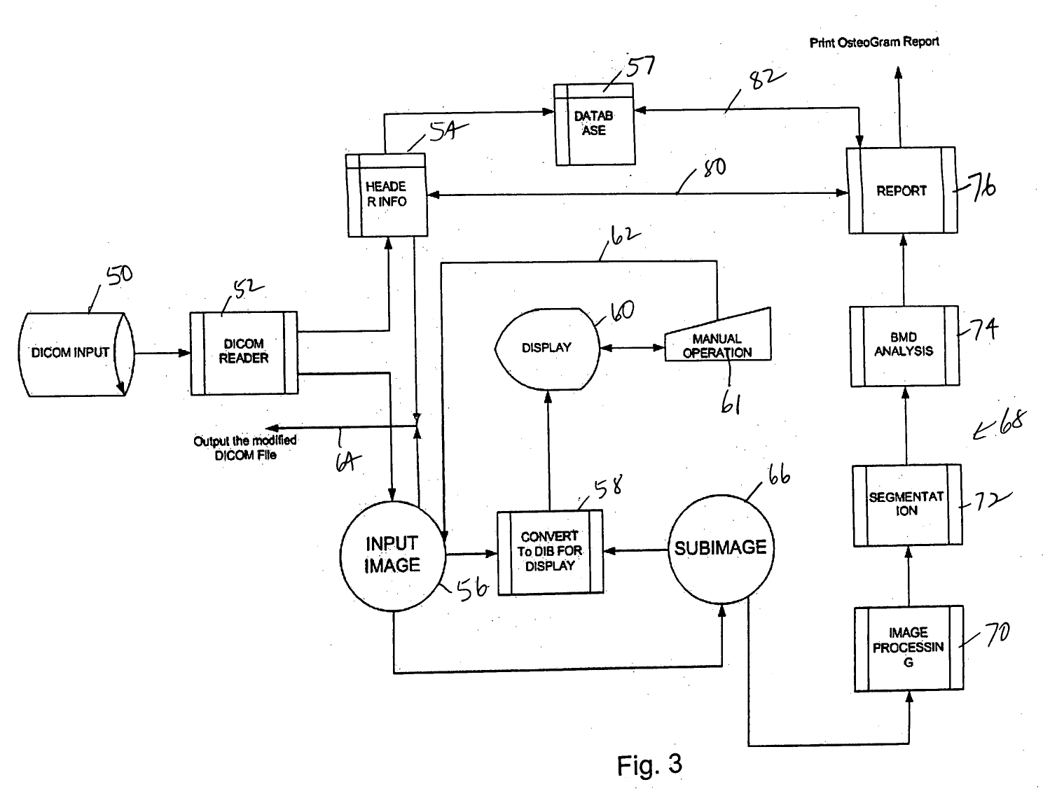

FIG. 3 illustrates components of the system for processing a patient image to determine bone mineral density (BMD) at a local site computer, in accordance with the invention. A DICOM file containing both a digital image and patient information is stored at a remote server site, e.g., PACS, as noted above. This file is retrieved at 50, and read by a DICOM reader 52 contained on the local site computer. Using the DICOM reader, the user can open the stored input image, at 56, and also the patient-information file (header information), at 54. The header information, in turn, can be placed in a database 57 of patient information containing, for example, patient information for all patients at a given clinic or hospital.

The input image may be processed manually or by an automated analysis program. In the operation, the input image is converted to both a device-independent bitmap (DIB) at 58, which is then displayed to the user at 60, and a TIFF image for analysis. The user may manually process or analyze the image at 61, for example, to segment the image, or to segment a patient bone, e.g., phalange, or to define and measure bone shape and dimensions, in particular, bone contours and dimensions. The processed image may then be returned to the DICOM image file, as at 62, for return to the archival source of the file, as at 64.

Because only a portion of the image may be used for BMD analysis, e.g., the middle phalange of one of the digits, this portion may be extracted, along with the calibration wedge, and presented as a subimage at 66. As shown, the subimage may be converted to a DIB image at 58, for display, or may be used as the image input for a program 68 in the remote-site computer for automated determination of BMD.

As shown, program 68 includes four modules, which are detailed in above above-cited '745 patent and '282 patent. Briefly, an image processing module 70 functions to calibrate bone size and density (gray-scale pixel values), using the calibration wedge to normalize density and bone size.

A segmentation module 72 then segments each of the three digits and finds a central axis for each of the digits and the calibration wedge, finds left and right bone edges of each digit, locates joint edge points from the left and right bone edges, for determining the top, bottom, left, and right bone contours of the middle phalange, and uses this information to form a contour of the middle phalange. The module then outputs the three contours of the middle phalange bone and the contours of the wedge for bone density analysis.

This contour information is used in a BMD analysis module 74 to determine the bone mineral density of every phalange. Briefly, this module first calculates wedge calibration factors, then divides each phalange into four phases, and sorts the contour for each phase. This module then calculates the bone mineral mass and bone volume of each phase in every phalange, and from this, calculates the bone density of every phalange. A report module 76 operates to generate an osteogram report which includes patient information, taken from the patient data section of the DICOM file, as indicated at 80, and information related to bone mineral density, T score, indicating a standard deviation above or below mean BMD for young normal adults, and skeletal status. As seen, the report information may be supplied to the database of patient information, as at 82, and may be added to the DICOM patient-data section at 80. The modified DICOM file may then be transmitted to the DICOM archival site and/or to another remote site, as at 64.

The operations described with respect to FIG. 3 illustrate a typical distribution of activities that can be performed with the system of the invention, where a patient file may be established at one site, a digital radiographic image taken at the same or a second site, image analysis performed at another site, and reporting and patient consultation carried out at still another site. In the embodiment shown, the remote-site computer contains an integrated software package capable of (i) opening a DICOM-compliant file to retrieve radiographic image(s) and patient information therefrom, (ii) carry out bone analysis operations on the retrieved image, (iii) enter new patient information, such as bone mineral mass, bone volume, bone mineral density, T-score, Z-score, fracture prediction, and a diagnostic statement, in the patient-data file, and (iv) send the modified file to other sites, e.g., an archival site. Optionally, the software package is also designed to set up a new DICOM file, and enter radiographic image(s) and patient information in the two file sections. That is, the software package is designed to allow at least one computer in the system to carry out every aspect of establishing, using, and sending patient files in DCOM-compliant form.

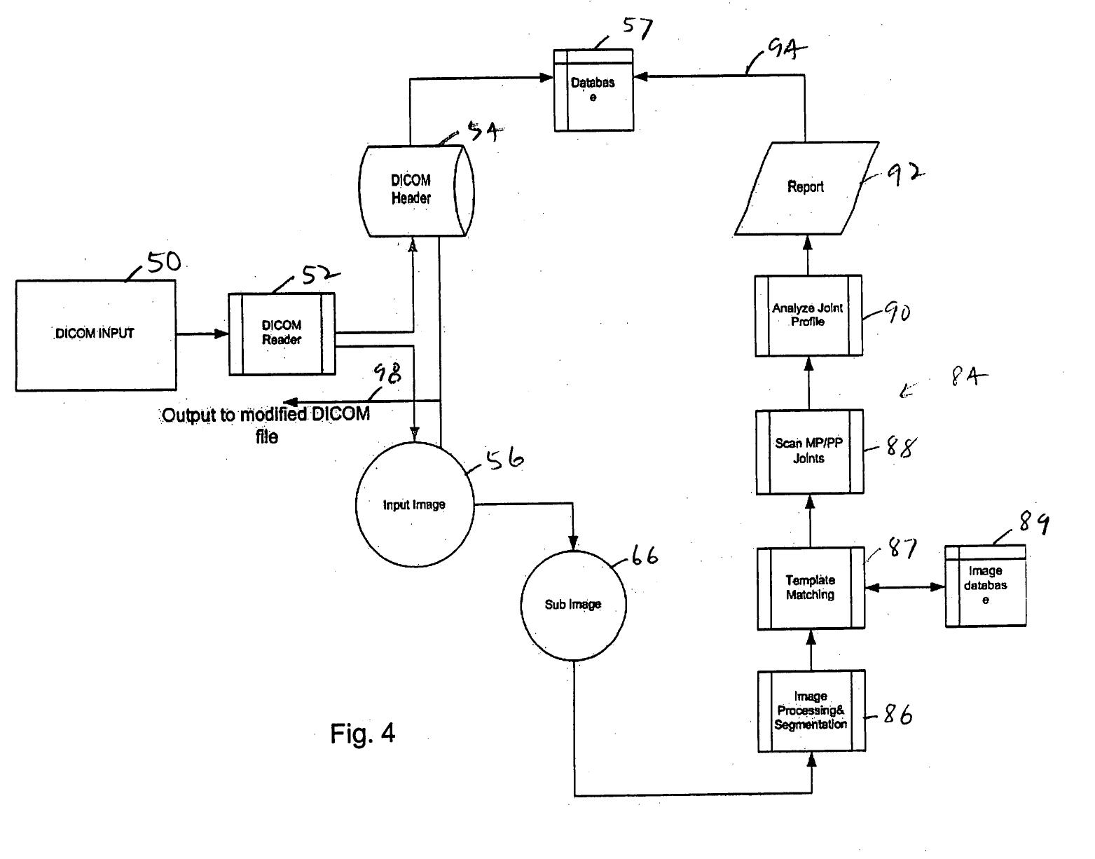

FIG. 4 illustrates another application of the invention, where the DICOM file is used in operations for determining and monitoring patient joint pathology, e.g., degeneration, associated with arthritis. The components and operations at the left in the figure, which involve retrieving a stored DICOM file, and extracting the image and patient-data sections at a remote-site computer, are similar to those identified by the same numbers in FIG. 3. A remote-site computer, such as a subimage 66 constructed from the DICOM image section is input to a computer program 84 designed for automated analysis of joint condition, e.g., related to a joint degenerative condition such as rheumatoid arthritis. This program is detailed in the above-cited '943 application.

Briefly, an image processing and segmentation module 86 functions to calibrate the digitized image, segment the images into three phalanges for each digit and find the central axis of each digit, and determine right and left contours of at least a middle region of the middle phalange of each digit. A matching module 87 accesses a database 89 of normal-finger templates, to identify a template that most closely matches the subject finger. This template is superimposed on the image of the patient-finger middle phalange, in a scanning module 88, to identify a scanning box at the middle phalange/proximal phalange (MP/PP) joint. Module 88 then scan this box, in scanning directions parallel to the axis of the finger, to generate contours of the confronting ends of the middle and proximal phalanges in the MP/PP joint.

A fourth module 90 in the program generates a profile of the distances between the MP/PP bone-end contours within said scan box, and from this profile, determines the extent of bone loss at the MP/PP joint, as an indicator of extent or progression of joint-degenerative disease in the patient. A patient report, which may include information about extent of joint degeneration, the change in joint condition over time, and T and Z value scores for osteoporosis, are generated by a report module 92. As with the application described with respect to FIG. 3, the report data may be added to a patient database 57, as at 94, and also added to the patient-data section in the patient DICOM file, as at 96. The modified DICOM file may then be transmitted to the DICOM archival site and/or to another remote site, as at 98.

As with the application described with respect to FIG. 3, the operations described here illustrate a distribution of activities that can be performed with the system of the invention, in this case, for monitoring and diagnosing joint-disease conditions, where file set-up, taking radiographic images, performing automated analysis of joint conditions, and physician reporting and patient consultation are carried at two or more sites, with at least one computer preferably having a software package that allows all of the above operations to be performed at a single site.

Thus, as illustrated for both systems above, one site may be equipped to handle all of the necessary computer operations, while other sites may have more limited capabilities, e.g., only file-viewing privileges, or ability to add image and patient information. All sites, of course, will have the ability to receive and view DICOM-compliant files.

FIG. 5 illustrates a DICOM-compliant file 100 for a patient, in accordance with the invention. Included in the file are a header subfile 102, and subfiles 104 and 106 for patient demographics and diagnostic results, respectively. The header subfile includes patient and file-identifying information such as patient name, age, address, referring physician, and the like. The patient demographics subfile is designed to receive patient demographic information, such as information related to the radiographic image—when, where, and how it was made and by whom—and previous medical history, including the names or addresses of referring or treating physicians.

As shown in the figure, diagnostics subfile 106 contains fields or tags for T-score and Z-score values for BMD, fracture risk prediction, bone density, and doctor's comments. The program may also allow the user to create new tags, such as for information, such as tags for bone mineral mass, bone volume, bone length, cortical thickness, cortical bone mass, and trabecular bone mass. The subfiles are designed to receive file information in DICOM compliant form, that is, the program generates suitable Java Script commands and JPEG images for entering and storing the data and images in the file, as will now be described.

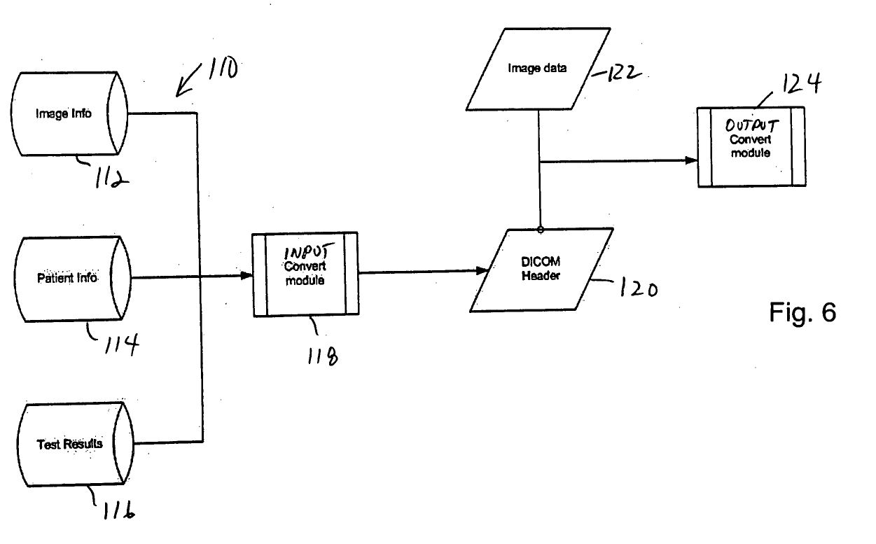

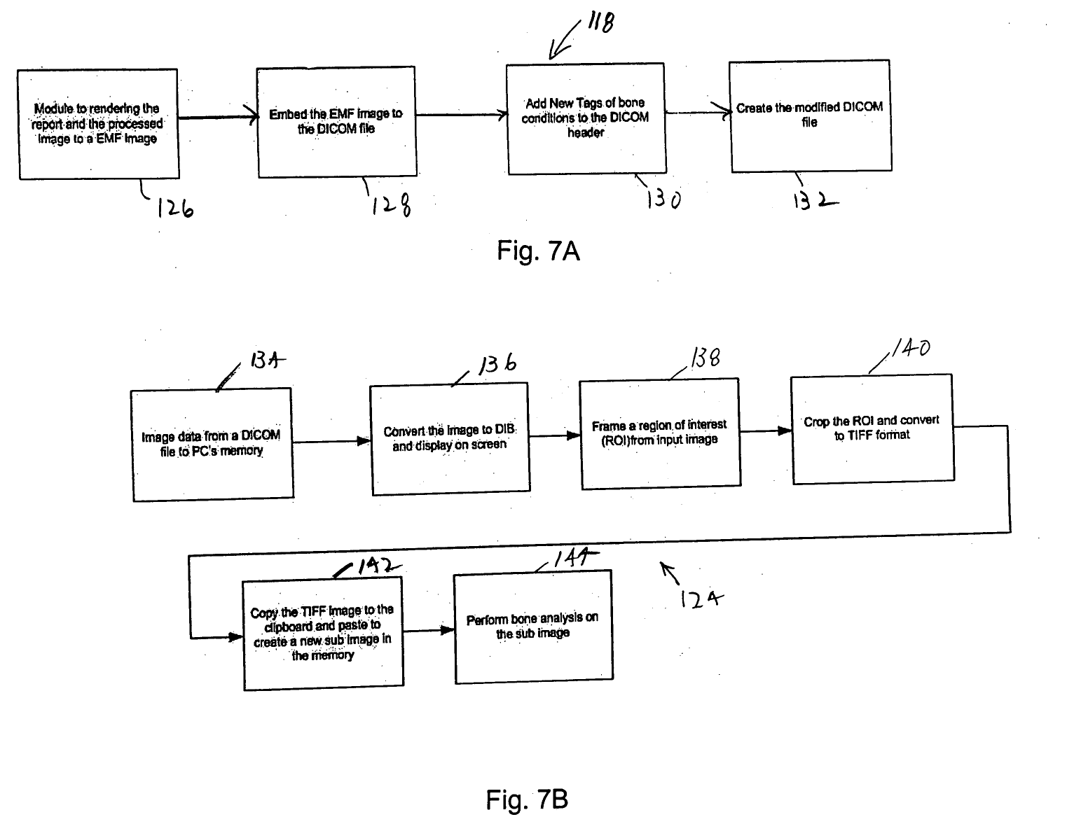

Program components for moving patient data and images in and out of DICOM-compliant files is shown in FIG. 6. Initially, in setting up a new DICOM file, patient information 110, in the form of a radiographic image and patient information are converted, by an input convert module 118, to a DICOM-compliant form and placed in the appropriate sub files (above) of the DICOM file. As noted, the system software includes the convert module which generates the DICOM commands, Java Script commands and JPEG images for formatting the patient information and radiographic images in a DICOM file. More specifically, as described with respect to FIG. 7A, below, the module places radiographic image(s) into the image data section of the file, shown at 122, and patient information into the DICOM header, shown at 120.

An output convert module 124 in the program, described with respect to FIG. 7B below, contains the necessary format commends to retrieve image and patient data files from the DICOM file, and convert these to image and information files usable in one of the computer programs, such as a one of the above described bone or joint analysis programs. Similarly, any new image or patient or diagnostic information can be placed in the existing DICOM file, by convert module 118, and retrieved from the file, by convert module 124.

FIG. 7A is a block diagram of operations carried out by the input convert module 118, that is in setting up and adding patient information to a DICOM-compliant file. A first module 126 functions to render a patient file report and processed image to an enhanced metafile (EMF), according to known file-conversion methods. The EMF is then embedded in a standard DICOM file, as at 128. The user may here specify, as at 132, the addition of new tags to the standard DICOM file, such as bone mineral mass, bone volume, bone mineral density, bone length, cortical thickness, cortical bone mass, trabecular bone mass, T-score, Z-score, and fracture risk prediction. By these steps, the program creates a modified DICOM file, as at 132, which contains patient header information, new tags for additional patient information, and any image file(s). FIG. 7B illustrates operations carried out by module 124 in reading an existing DICOM file into a user remote-site computer, e.g., PC. The image data from the DICOM file is initially read to the computer memory at 134, and this image is converted by the computer program to a DIB and displayed on the computer screen at 136. The user can then frame a region of interest (ROI) on the screen image, at 138, and this image may be cropped and converted to a TIFF format, at 140. The user can now copy the TIFF file to the computer clipboard and paste to create a new subimage in the computer memory, as at 142. The analysis algorithms are performed on this subimage, as at 144, to generate the desired bone analysis information, such as discussed above with reference to FIGS. 3 and 4.

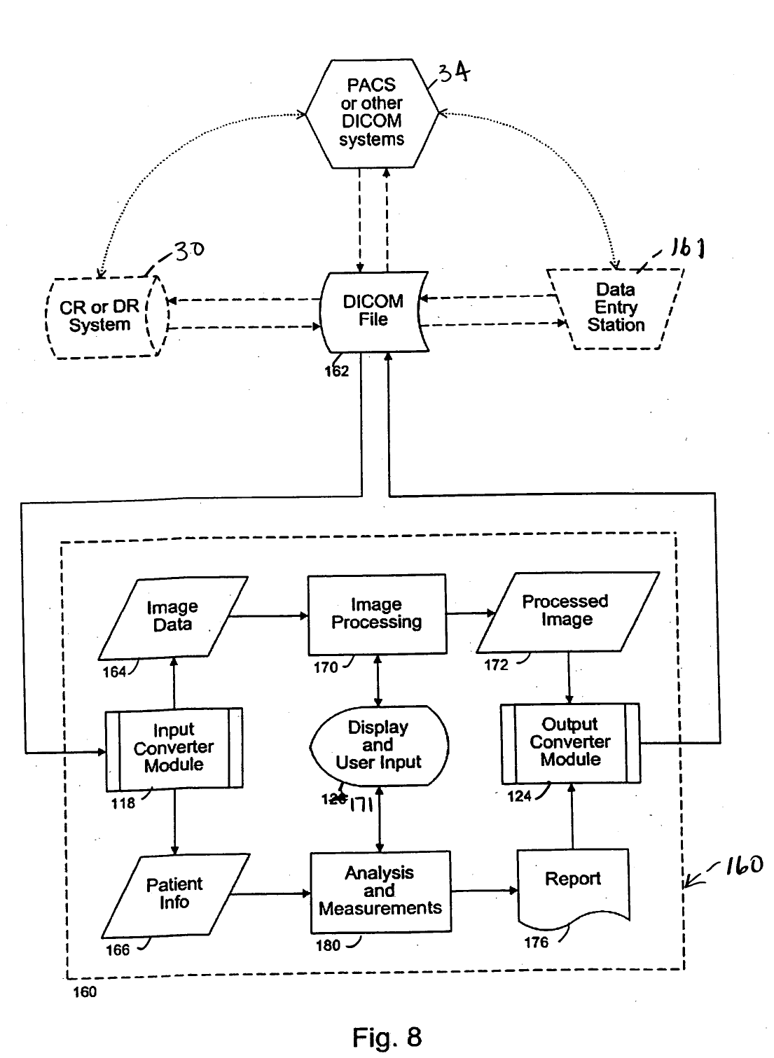

FIG. 8 shows components and files in the system software described in various embodiments above, and indicated generally by the components and files within dotted line 160. These operations and functions are performed by a remote-site computer. Patient input used in constructing a new or modified patient DICOM file 162 is provided from a CR or DR system 30 and from a data-entry station 161. Alternatively, an existing DICOM compliant file can be retrieved from a PACS or other DICOM archival system 34. The archived or newly created DICOM file is accessed by covert module 118 in the computer, to format patient image and information for image subfile 164 and patient information subfiles 166, as described above with reference to FIG. 7A. As noted above, converter 118 converts patient image and data information into a form suitable for processing in the computer. For example, image data at 164 may be processed at 170, displayed to the user, at 171, for example, to select a suitable subimage for image analysis. The processed image may also be stored at 172 for inclusion in a modified DICOM file. Box 180 in the figure represents one or more analytical algorithms for analyzing patient images supplied from 170 or 171, to determine or assay various bone or joint conditions, such as BMD or joint degeneration, as described above with reference to FIGS. 3 and 4. The analytical determinations are combined with patient information from converted file 166 for generating a patient report, at 176. Finally, this report, and well as processed image (s) from 172 can be converted to DICOM-compliant form by module 124 for modifying or adding to DICOM file 162.

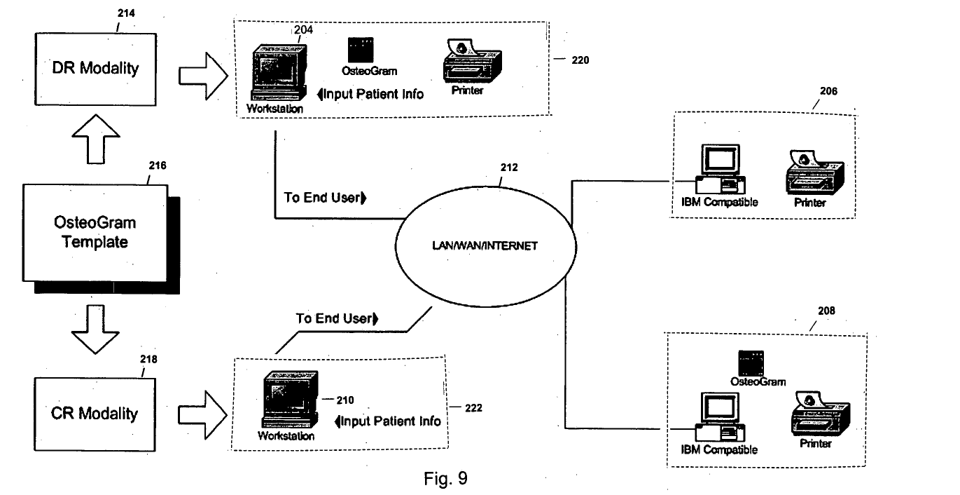

FIG. 9 shows different components and sites involved in another exemplary DICOM-compliant system in accordance with the invention. A bone analysis software (e.g., an image processing software, OsteoGram) is installed on a workstation 204 of a CR 218 or DR 214 modality at an X-ray facility site 220. When an image is captured using the CR or DR, it is saved to the memory of the workstation or formatted as a DICOM compliant file that will be saved to a dedicated directory. The software will perform analysis on the image and create a report. The report can be printed out immediately for the patient in the facility 220 or it can be saved as a DICOM compliant file with the results embedded in the file's header. The file can be sent to doctors at a different site 206 by a LAN, WAN or Internet 212. The doctor can also print the report using a local printer if it is needed.

In another embodiment, the software is installed at a computer in a doctor's office 208. When an image is obtained by a CR 218 or DR 214 at an X-ray facility site 222, it is saved as a DICOM compliant file with the patient information embedded in the file's header and directly sent to the doctor's office 208 for analysis by LAN, WAN or Internet 212 from a workstation 210 in the facility 222. After the image is received in the doctor's office 208, the software will be used to perform the analysis and a report will be created. It can be printed out through a local printer or it can be saved as a DICOM file for archive purpose.

From the foregoing, it will be appreciated how various objects and features of the invention are met. The system allows for various bone diagnostic and treatment activities, including initial patient consultation, preparing radiographic images, analyzing images for diagnostic purposes, interpreting output data, and physician consultation and treatment to be carried out at the same site or different remote sites, to be carried efficiently by a number of different health-care specialists at the same or different sites, and without risk of losing critical radiographic images, patient information, or diagnostic comments made to the patient record. Further, the complete file can be easily retrieved by any physician at a later time, for purposes of updating a patient's condition, or assessing changes to a patient's condition over time.

Another aspect of the present invention is directed to the installation of bone analysis software in a server that performs the analysis and delivers an analysis result to a user. The bone analysis software includes an OsteoGram software which include those as described in the '745 patent, the '943 Application, and the '282 patent.

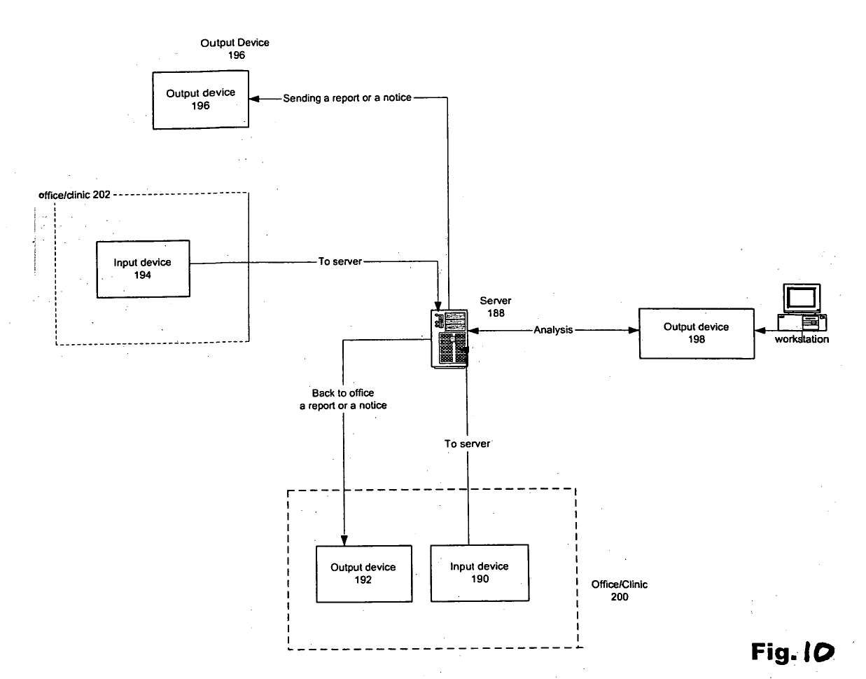

As shown in FIG. 10, a digital image of a bone from a subject is obtained in a clinic 200 or 202. The image, along with other information (e.g., a subject's or a patient's information), is formatted into a file (e.g., a DICOM file) through, for example, commonly known the Digital Image Communication in Medicine (DICOM) system. The file is sent to and stored in a server 188 through an input device 190 via wired or wireless network protocols. One example of the protocols is the Picture Archive Communication System (PACS). In another embodiment, the file is saved into a medium (e.g., a disk, a memory card, CD disc, DVD disc) and the medium is send to a user at the server 188 location or a user at location 198. The user then downloads the file into the server 188 and conducts an analysis using bone analysis software installed at server 188.

An input device used herein or in the present application may include any of a variety of known devices for accepting and processing input information from a user, whether a human or a machine, whether local or remote. Such input information include a digital image of a bone, a digital image suitable for formatting for a DICOM file, a digital image in DR format, a digital image in CR format, the information about a subject whose bone condition is subject to an analysis by a bone analysis software. Such input devices include, for example, workstation, modem cards, network interface cards, sound cards, keyboards, scanners, CD Reader/Writer or DVD Reader/Writer, memory card, flash card, digitalizer equipment, or other types of controllers for any of a variety of known input function.

The server 188, which has a bone analysis software installed, receives and archives the file. The server 188 performs the analysis of the digital image through an automatic or manual process and generates a report presenting analysis data. In the case of the automatic process, the server automatically initiates the computer aid analysis upon the receipt of the file if the file contains an instruction message (e.g., a dedicated TAG in a file header) to trigger the server to start the analysis process. In the case of the manual process, a user (e.g., a doctor) at the office location 200 may upload the file to server 188, conduct the bone analysis using the software installed in the server 188, and obtain an analysis result. In another manual process, the server sends out a notice to an output device 198 to inform an analysis user (e.g., a radiologist) of the arrival of the file. The analysis user can then access the server through any types of network protocol, wired or wireless, to analyze the image using the software installed in the server 188.

Alternatively, the server 188 does not have to send out a notice. An analysis user may routinely or periodically access to the server 188 and analyze any images arriving at the server or any installed images. An output device used herein or in the present application may include controllers for any of a variety of known devices for presenting information to a user, whether a human or a machine, whether local or remote. Such output devices include, for example, modem cards, network interface cards, sound cards, display devices (e.g., monitors or printers), fax machines, beepers, mobile phones, computer medium, disk, CD reader/writer, DVD reader/Writer, memory card, blackberries, palms, or other types of controllers for any of a variety of known output function. If a display device provides visual information, this information typically may be logically and/or physically organized as an array of picture elements, sometimes referred to as pixels.

After the performance of an analysis, the serve 188 then generates a report presenting the result of the analysis. The report may also include information in the file such as the subject's information and the digital image. An invoice can also be created based on the use of the software in the server as well as the involvement of a user (e.g., a radiologist) in analyzing the image. The server 188 can then send the information regarding to the analysis to the original user who submits the image or file. In the meantime, the original file, the report, and the invoice are saved in the server's archive system or database.

In one embodiment of the present invention, the server 188 may print the report and/or the invoice to an output device (e.g., a printer, a fax machine) in an office or clinic 200. The server 188 may send the report and/or the invoice in a file format to the original user through an output device electronically. In this case, the user receives the report and or the invoice in the output device (e.g., mobile phones, computer terminals, e-mail folders, blackberries, and palms). The file can be in any format, such as, JPEG, GIF, EMF, BMP, TIFF, Postscript, PDF, WORD, and another DICOM file.

In another embodiment of the present invention, the server 188 may send out a notice, a link, or an item number to an output device 192 or 196 and inform a user of the created report and/or the invoice. The user can then access to the server through any known network protocol, wired or wireless, identify the report/invoice with the link or the item number, download the report and/or invoice in a file format through the network, send the link via a network protocol to another user (e.g., a insurance carrier), or directly print the report/invoice in an output device.

It is contemplated that an output device 192 may be in the same location as an input device 190. Alternatively, an output device 196 may be in a different location from an input device 194. It is also contemplated that the report and/or the invoice can also be sent to a user (e.g., physicians) through a manual mail service.

Having bone analysis software installed in a server to perform the analysis, a user (e.g., a doctor) obviates the need of purchasing the software up-front. Rather, the user can fully utilize each function of the software on a pay-per-use basis.

The report contains the bone analysis results and a subject's information, which easily help a doctor or a radiologist to diagnose a bone condition or a predisposition to a bone condition. The results contain commonly known parameters in the diagnosis of a bone condition, such as bone volume, bone length, bone geometric change, bone strength, bone age, bone cortical thickness, bone mineral mass, T-score, Z-score, and the bone mineral density (BMD).

The report generated in the server streamlines the reimbursement process in a clinic or a doctor's office. For example, usually a bone diagnosis service needs to be reimbursed from an insurance carrier. Since the analysis results, images and patient information, and the invoice associated with the use of the server are already saved in the server's archive system, a user can access to the server to pull out the information to fill in a claim form. In addition, the reports, the invoice, and a subject's information can be easily customized and reformatted into a file automatically in accordance with each insurance carrier's requirements. A user (e.g. a physician) can directly send the file or a link to the file to the insurance carrier electronically or print and send out a physical copy for reimbursement.

The aforementioned server system containing bone analysis software can be used to diagnose a bone condition. Bone conditions include arthritis diseases (e.g., rheumatoid arthritis, osteoarthritis, infectious arthritis, osteomyelitis), scoliosis, fracture, gout, bone cysts, osteoporosis, osteopetroses, osteoscleroses, craniotubular dysplasias, craniotubular hyperostoses, and sclerosteosis. In addition, bone conditions include bone age, bone volume, bone length, bone geometric changes, bone strength, bone cortical thickness, and bone mineral mass. Furthermore, bone conditions include dental conditions such as tooth decay, dental plaque, pulpitis, periapical abscess, and periodontal diseases (e.g., gingivitis and periodontitis).

The methods and systems according to the present invention can also be used to diagnose a disease or condition which is associated with the change of the optical density of cells, tissues or organs of a subject. The optical density of a material relates to the sluggish tendency of the atoms of a material to maintain the absorbed energy of an electromagnetic wave in the form of vibrating electrons before reemitting it as a new electromagnetic disturbance. The optical density of a material is inversely related to the speed of a wave that moves through the material. Since a diseased tissue or organ may change the optical density due to a disease, the diseased tissue or organ may cast a digitized radiographic image different from that of a normal tissue or organ. Accordingly, the radiographic image can be analyzed using the methods and systems according to the present invention and used to determine the onset, predisposition, or stage of a disease. Diseases herein include infectious diseases, cardiovascular disorders, pulmonary disorders, gastrointestinal disorders, hepatic and binary disorders, musculoskeletal and connective tissue disorders, neurologic disorders, ophthalmologic disorders, dermatologic disorders, dental and oral disorders (e.g., gingivitis & periodontitis), tissue or organ wounds, and tumors (e.g., benign tumor and cancer).

Computer and Server. It is desirable that a bone analysis or the involvement of a server, an input device and an output device according to the present invention are performed to automate the process through the use of a computer system or a serve system.

A computer system (e.g., a server system) according to the present invention refers to a computer or a computer readable medium designed and configured to perform some or all of the methods as described herein. A computer (e.g., a server) used herein may be any of a variety of types of general-purpose computers such as a personal computer, network server, workstation, or other computer platform now or later developed. As commonly known in the art, a computer typically contains some or all the following components, for example, a processor, an operating system, a computer memory, an input device, and an output device. A computer may further contain other components such as a cache memory, a data backup unit, and many other devices. It will be understood by those skilled in the relevant art that there are many possible configurations of the components of a computer.

A processor used herein may include one or more microprocessor(s), field programmable logic arrays(s), or one or more application specific integrated circuit(s). Illustrative processors include, but are not limited to, Intel Corp's Pentium series processors, Sun Microsystems' SPARC processors, Motorola Corp.'s PowerPC processors, MIPS Technologies Inc.'s MIPs processors, Xilinx Inc.'s processors, and Vertex series of field programmable logic arrays, and other processors that are or will become available.

An operating system used herein comprises machine code that, once executed by a processor, coordinates and executes functions of other components in a computer and facilitates a processor to execute the functions of various computer programs that may be written in a variety of programming languages. In addition to managing data flow among other components in a computer, an operating system also provides scheduling, input-output control, file and data management, memory management, and communication control and related services, all in accordance with known techniques. Exemplary operating systems include, for example, a Windows operating system from the Microsoft Corporation, a Unix or Linux-type operating system available from many vendors, another or a future operating system, and some combination thereof.

A computer memory used herein may be any of a variety of known or future memory storage devices. Examples include any commonly available random access memory (RAM), magnetic medium such as a resident hard disk or tape, an optical medium such as a read and write compact disc, or other memory storage device. Memory storage device may be any of a variety of known or future devices, including a compact disk drive, a tape drive, a removable hard disk drive, or a diskette drive. Such types of memory storage device typically read from, and/or write to, a computer program storage medium such as, respectively, a compact disk, magnetic tape, removable hard disk, or floppy diskette. Any of these computer program storage media, or others now in use or that may later be developed, may be considered a computer program product. As will be appreciated, these computer program products typically store a computer software program and/or data. Computer software programs typically are stored in a system memory and/or a memory storage device.

As will be evident to those skilled in the relevant art, a computer software program of the present invention can be executed by being loaded into a system memory and/or a memory storage device through one of input devices. On the other hand, all or portions of the software program may also reside in a read-only memory or similar device of memory storage device, such devices not requiring that the software program first be loaded through input devices. It will be understood by those skilled in the relevant art that the software program or portions of it may be loaded by a processor in a known manner into a system memory or a cache memory or both, as advantageous for execution and used to analyze a bone condition.

In one embodiment of the invention, bone analysis software is stored in a computer server that connects to an end user terminal, an input device or an output device through a data cable, a wireless connection, or a network system. As commonly known in the art, network systems comprise hardware and software to electronically communicate among computers or devices. Examples of network systems may include arrangement over any media including Internet, Ethernet 10/1000, IEEE 802.1 1x, IEEE 1394, xDSL, Bluetooth, 3G, PACS, or any other ANSI approved standard.

Although the invention has been described with reference to particular embodiments and applications, it will be appreciated that various changes and modifications may be made without departing from the invention.

1. A method for in use in diagnosing or monitoring a bone or joint condition in a patient, comprising
(a) obtaining a digitized, radiographic image of (i) a skeletal region of the patient and (ii) a reference wedge by which anatomical features of the skeletal region can be calibrated,
(b) entering said radiographic image in the image section of a DICOM file also containing a patient-data section,
(c) applying bone-analysis software to the digitized radiographic image to obtain data relating to such bone or joint condition, and
(d) entering data from step (c) in the patient-data section of the DICOM file.

2. The method of claim 1, which includes establishing a DICOM file at a first site, adding patient information to the patient-data section at the first site, and sending said file to a second site where the digitized radiographic image is analyzed.

3. The method of claim 2, wherein steps (c)-(d) are carried out at the second site.

4. The method of claim 1, wherein steps (a) and (b) are carried out at a first site, and steps (c) and (d) are carried out at a second site.

5. The method of claim 1 wherein steps (a)-(d) are carried out at the same site.

6. The method of claim 1, wherein step (c) includes transferring the digitized radiographic image in a DICOM compliant file to a site computer and applying said software at the site computer, to obtain data relating to such bone or joint condition, and step (d) includes transferring such data from the site computer to the DICOM patient-data file.

7. The method of claim 6, wherein the software in the site computer is operable to open a DICOM file, input digitized radiographic images from the DICOM file to the site computer and, after applying said software to obtain data relating to such bone or joint condition, to transfer such data from the site computer to the DICOM patient-data file.

8. The method of claim 7, wherein the DICOM sections are accessed as a component object module (COM) on a Picture Archiving and Communications System (PACS).

9. The method of claim 1, for use in assaying or monitoring changes in bone mineral density in a patient, wherein the step (a) is carried out to obtain a digitized, radiographic image of (i) one or more fingers of one of the patient's hand, and step (c) includes segmenting the middle phalange of at least one finger in the radiographic images, and determining a bone mineral density value based on the contours of each segment in the phalange of said finger.

10. The method of claim 1, for use in assaying or monitoring the progression of a joint degenerative disease such as rheumatoid arthritis and osteoporosis in changes in bone mineral density in a patient, wherein the step (a) is carried out to obtain a digitized, radiographic image of (i) one or more fingers of one of the patient's hand, and step (c) includes:
(i) determining right and left bone contours of at least a middle region of the middle phalange of said finger,
(ii) matching said right and left bone contours in a middle region of the middle phalange of the patient finger with those of a normal-finger template, to identify a normal-finger template that matches the patient finger,
(iii) superimposing the normal-finger template middle phalange on the image of the patient-finger middle phalange,
(iv) using the contours of the template finger to identify a scanning box at the middle phalange/proximal phalange (MP/PP) joint,
(v) scanning the MP/PP joint within said scanning box, in scanning directions substantially parallel to the axis of the finger, to generate contours of the confronting ends of the middle and proximal phalanges in said MP/PP joint,
(vi) generating a profile of the distances between said MP/PP bone-end contours within said scan box, and
(vii) analyzing said profile from (g) to determine the extent of bone loss at the MP/PP joint, as an indicator of extent or progression of joint-degenerative disease in said patient.

11. The method of claim 1, wherein said patient-data section includes tags to identify various types of patient information, and the method further includes adding to the patient-data section, additional tags for entering data relating to the patient's osteoporosis status, including one or more of bone mineral mass, bone volume, bone length, bone geometric changes, bone age, bone strength, cortical thickness, cortical bone mass, trabecular bone mass, T-score, Z-score, fracture probability prediction, and diagnostic statement.

12. A system for use in use in diagnosing or monitoring a bone or joint condition in a patient, comprising
(1) a template for use obtaining a radiographic image of a skeletal region of one of the patient's hands, said template indicating the placement of the hand on the template and an x-ray wedge by which anatomical features of the skeletal region can be calibrated in a radiographic image of the patient's hand placed on the template, and
(2) software designed to be executed on a site computer, operable to:
(a) transfer said radiographic image, in digitized form, to and from the image section of a DICOM file also containing a patient-data section,
(b) apply bone-analysis software to the digitized radiographic image, to obtain data relating to such bone or joint condition, and
(c) allow entry data from step (b) in the patient-data section of the DICOM file.

13. The system of claim 12, for use in assaying or monitoring changes in bone mineral density in a patient, wherein the template is used in obtaining a digitized, radiographic image of (i) one or more fingers of one of the patient's hand, and step (b) includes segmenting the middle flange of at least one finger in the radiographic images, and determining a bone mineral density value based on the contours of each segment in the phalange of said finger.

14. The system of claim 12, for use in assaying or monitoring the progression of a joint degenerative disease such as rheumatoid arthritis and osteoporosis in changes in bone mineral density in a patient, wherein the template is used in obtaining a digitized, radiographic image of (i) one or more fingers of one of the patient's hand, and step (b) includes:
(i) determining right and left bone contours of at least a middle region of the middle phalange of said finger,
(ii) matching said right and left bone contours in a middle region of the middle phalange of the patient finger with those of a normal-finger template, to identify a normal-finger template that matches the patient finger,
(iii) superimposing the normal-finger template middle phalange on the image of the patient-finger middle phalange,
(iv) using the contours of the template finger to identify a scanning box at the middle phalange/proximal phalange (MP/PP) joint,
(v) scanning the MP/PP joint within said scanning box, in scanning directions substantially parallel to the axis of the finger, to generate contours of the confronting ends of the middle and proximal phalanges in said MP/PP joint,
(vi) generating a profile of the distances between said MP/PP bone-end contours within said scan box, and
(vii) analyzing said profile from (g) to determine the extent of bone loss at the MP/PP joint, as an indicator of extent or progression of joint-degenerative disease in said patient.

15. The system of claim 12, wherein said software is operable to open a DICOM file, transfer digitized radiographic images from the DICOM file to the site computer and, after applying said software to obtain data relating to such bone or joint condition, to transfer such data from the site computer to the DICOM patient-data file.

16. The system of claim 15, wherein the software is operable to access the DICOM file as COM on a Picture Archiving and Communications System (PACS).

17. A computer system for analyzing a bone condition comprising a server, wherein the server contains a bone analysis software and is used by a user to:
(i) receive a file containing a bone image;
(ii) analyze the bone image using the software on the server; and
(iii) deliver an analysis result to the user.

18. The computer system of claim 17 wherein the analysis result comprising a report.

19. The computer system of claim 17 wherein the bone condition is selected from the group consisting of bone mineral mass, bone volume, bone length, bone geometric changes, bone age, bone strength, cortical thickness, cortical bone mass, trabecular bone mass, T-score, Z-score, arthritis diseases, scoliosis, fracture, gout, bone cysts, osteoporosis, osteopetroses, osteoscleroses, craniotubular dysplasias, craniotubular hyperostoses, and sclerosteosis.

20. The computer system of claim 17 where in the bone analysis software is an OsteoGram software.

21. A method of analyzing a bone condition using a bone analysis software installed in a server comprising the steps of:
(i) sending a file containing a bone image to a server wherein the server contains bone analysis software;
(ii) analyzing the bone image using the software in the server,
(iii) receiving an analysis result from the server.

22. The method of claim 21 wherein the analysis result comprising a report.

23. The method of claim 21 wherein the bone condition is selected from the group consisting of bone mineral mass, bone volume, bone length, bone geometric changes, bone age, bone strength, cortical thickness, cortical bone mass, trabecular bone mass, T-score, Z-score, arthritis diseases, scoliosis, fracture, gout, bone cysts, osteoporosis, osteopetroses, osteoscleroses, craniotubular dysplasias, craniotubular hyperostoses, and sclerosteosis.

24. The method of claim 21 where in the bone analysis software is an OsteoGram software.
